(19) United States
(12) Patent Application Publication
(10) Pub. No.: US 2009/0085245 A1
(43) Pub. Date: Apr. 2, 2009

(54) METHOD FOR PRODUCING FILM

(75) Inventors: Kousuke YAMAKI, Kanagawa (JP); Toshinao ARAI, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/234,668

(22) Filed: Sep. 21, 2008

(30) Foreign Application Priority Data
Sep. 28, 2007 (JP) 2007-255825

(51) Int. Cl. B29C 55/08; B29C 39/22

(52) U.S. Cl. 264/212

(57) ABSTRACT

In a first tenter, a wet film is stretched at an average atmospheric temperature of not less than 70° C. and not more than 115° C. until its residual solvent content is reduced to 25 wt. %. Thus, an intermediate film is produced. Then, in the first tenter, the intermediate film is dried at an average atmospheric temperature of not less than 40° C. and not more than 90° C. so as to reduce the residual solvent content to 10 wt. % or more and less than 25 wt. %. Thereafter, the intermediate film is conveyed to a second tenter. In the second tenter, the intermediate film having the residual solvent content of at most 10 wt. % is stretched at an atmospheric temperature set at not less than 160° C. and not more than 195° C. Thus, a film having a low Rth/Re, a high Re, and a low haze is produced.

### FIELD OF THE INVENTION

The present invention relates to a method for producing a film.

### BACKGROUND OF THE INVENTION

Performance required for a liquid crystal display (LCD) is becoming increasingly higher. The LCD has a structure in which optical films are layered. The optical films are required to have various optical properties so as to be compliant with various display formats of the LCD. In particular, it is necessary that the optical film has an in-plane retardation (hereinafter referred to as Re; unit: nm), a thickness retardation (hereinafter referred to as Rth; unit: nm) and a haze (unit: %) corresponding to the kind and the model of the LCD. The term “in-plane” refers to a direction of the plane vertical to the thickness direction of the film.

As is well known, the Re and the Rth are calculated by the following mathematical expressions (1) and (2) respectively.

Re=(nx−ny)×d (1)

Rth={(nx+ny)/2−nz}×d (2)

(wherein “nx” is a refractive index in a slow axis direction in the in-plane of the film, “ny” is a refractive index in a fast axis direction in the in-plane of the film, “nz” is a refractive index in a thickness direction of the film, and “d” is a thickness (nm) of the film.)

The Re, the Rth, and the haze of a polymer film, in particular, a film produced from cellulose acylate are adjusted by stretching the film so as to adjust orientation or a crystallization ratio of polymer molecules. Such film is particularly used as a retardation film for use in a polarizing filter of the LCD. To achieve a high Re, the film is stretched at a large stretch ratio, and the Rth also increases as the Re increases. However, it is demanded that the retardation film for use in the polarizing filter has optical properties with the high Re and a low Rth relative to the Re. The low Rth relative to the Re means that the Rth/Re is one or more and smaller than the conventional Rth/Re. In other words, the Rth/Re is closer to one than the conventional Rth/Re. It is also demanded that the produced film has a low haze.

In order to adjust the Re and the Rth of the polymer film, there are a method for producing a polymer film having a high Re and a high Rth in which a cellulose ester solution is cast on a support to form a casting film and the casting film is peeled off from the support as a wet film, and the wet film is stretched in a width direction while being dried when a residual solvent content of the wet film is within a predetermined range (see, for example, Japanese Patent Laid-Open Publication No. 2002-187960), and a method for producing a film having a low Re in which a casting film is peeled off as a film while a residual solvent content of the casting film is within a predetermined range, and then the film is stretched in two steps in a width direction (see, for example, Japanese Patent Laid-Open Publication No. 2002-311245). In addition, there is a method for producing a film having a high Re in which a retardation increasing agent is added to a polymer solution (see, for example, EP No. 1182470 A1 corresponding to WO 00/65384).

When the residual solvent content of the film is high, the stretch ratio of the film in the width direction and the stretching speed cannot be increased by the method described in Japanese Patent Laid-Open Publication No. 2002-187960 because the casting film is easily torn. In a case a drum is used as a support, and a casting film is solidified on the drum and then peeled off as a wet film so as to increase productivity, namely, a so-called cool-casting method described in Japanese Patent Laid-Open Publication No. 2002-187960, molecules are oriented in the conveying direction of the wet film when the casting film is peeled off. As a result, the Rth increases after the stretching of the wet film in the width direction. As a result, the Rth/Re cannot be reduced by the cool-casting method despite that the Re is increased.

In the method described in Japanese Patent Laid-Open Publication No. 2002-311245, a film is stretched in a first tenter and a second tenter downstream from the first tenter. A residual solvent content of the film is reduced to 10 wt. % to 50 wt. % before the film enters the first tenter. In order to dry the film so as to reach the above-mentioned residual solvent content before entering the first tenter, it is necessary to dry a casting film on a support. However, a so-called dry-casting method in which the casting film is dried on the support and peeled off as described above cannot achieve high production efficiency compared to the cool-casting method. In addition, this method is incapable of producing a film with a high Re and a low haze. On the other hand, in the method described in EP No. 1182470 A1 (corresponding to WO 00/65384), a retardation increasing agent is added to a casting film. As a result, the Rth increases together with the Re. Thus, the method is incapable of producing a film with desired optical properties.

### SUMMARY OF THE INVENTION

In view of the foregoing, an object of the present invention is to provide a method for producing an optical film having a high Re of at least 30 nm and a low Rth relative to the Re, and a low haze compared to a conventional film.

A method for producing a film according to the present invention has the following steps: forming a casting film by casting the dope containing cellulose acylate and a solvent onto a moving support; peeling the casting film as a film from the support after the casting film obtains self supporting property by cooling; a first step in which the film is dried at an average atmospheric temperature of not less than 70° C. and not more than 115° C. until a residual solvent content of the film is reduced to 25 wt. % while the film is stretched in the width direction; after the first step, a second step in which drying of the film is enhanced at an average atmospheric temperature of not less than 40° C. and not more than 90° C. so as to reduce the residual solvent content to 10 wt. %; and after the second step, a third step in which the film having the residual solvent content of 10 wt. % or less is stretched in a width direction at an atmospheric temperature set at not less than 160° C. and not more than 195° C.

It is preferable that a stretch ratio in the third step is not less than 10% and not more than 60%. It is preferable that the first step and the second step are performed using a pin tenter in which side edge portions of the film are held by pins. It is preferable that the third step is performed using a clip tenter in which side edge portions of the film are held by clips.

The optical film having the Re of at least 30 nm, the low Rth relative to the Re, and in which the haze is controlled at a low level is efficiently produced.

### BRIEF DESCRIPTION OF THE DRAWINGS

The above and other subjects and advantages of the present invention will become apparent from the following detailed description of the preferred embodiments when read in association with the accompanying drawings, which are given by way of illustration only and thus are not limiting the present invention. In the drawings, like reference numerals designate like or corresponding parts throughout the several views, and wherein:

FIG. 1 is a schematic view of a dope producing apparatus;

FIG. 2 is a schematic view of a solution casting apparatus according to a first embodiment of the present invention;

FIG. 3 is a schematic view of a wet film being held in a first tenter;

FIG. 4 is an explanatory view showing an increase in a width of the wet film in the first tenter;

FIG. 5 is an explanatory view showing an increase and a decrease in the width of an intermediate film in a second tenter; and

FIG. 6 is a schematic view of an off-line stretching device according to a second embodiment of the present invention.

### DESCRIPTION OF THE PREFERRED EMBODIMENTS

Hereinafter embodiments of the present invention are described in detail. However, the present invention is not limited to the following embodiments.

[Raw Material of Dope]

Cellulose acylate is used as a solute for a raw material of a dope. A solvent is not particularly limited as long as cellulose acylate is dissolved or dispersed therein. A dope is a polymer solution in which a polymer is dissolved in a solvent, or a dispersion liquid in which a polymer is dispersed in a dispersion medium. Cellulose acylate is detailed in paragraphs [0140] to [0195] of Japanese Patent Laid-Open Publication No. 2005-104148 and the descriptions can be applied to the present invention.

Specific examples of solvent compounds used for preparing the dope include aromatic hydrocarbon (for example, benzene, toluene and the like), halogenated hydrocarbons (for example, dichloromethane, chlorobenzene and the like), alcohols (for example, methanol, ethanol, n-propanol, n-butanol, diethylene glycol and the like), ketones (for example, acetone, methylethyl ketone, and the like), esters (for example, methylacetate, ethylacetate, propylacetate and the like), ethers (for example tetrahydrofuran, methylcellosolve and the like).

Among the above solvent compounds, the halogenated hydrocarbons having 1 to 7 carbon atoms are preferable, and dichloromethane is most preferable. In view of physical properties such as solubility of cellulose acylate, peelability of a casting film from a support, mechanical strength and optical properties of a produced film, it is preferable to mix at least one kind of the alcohols having 1 to 5 carbon atoms with dichloromethane. The content of the alcohol(s) is preferably in the range of 2 wt. % to 25 wt. %, and more preferably in the range of 5 wt. % to 20 wt. % with respect to total solvent compounds in the solvent. Preferable examples of the alcohols include methanol, ethanol, n-propanol, isopropanol, and n-butanol. Among the above alcohols, methanol, ethanol, n-butanol or a mixture thereof are preferable.

Various additives may be added to the dope. For example, a plasticizer, a deterioration inhibitor, a UV absorbent, an optical anisotropy controller, a dye, a matting agent, a peeling agent, a retardation increasing agent, and the like may be used.

Additives such as plasticizers, deterioration inhibitors, UV absorbents, optical anisotropy controllers, dyes, matting agents, and peeling agents are detailed in paragraphs [0196] to [516] of Japanese Patent Laid-Open Publication No. 2005-104148 and the descriptions can be applied to the present invention.

Paragraphs from [0030] to [0142] of Japanese Patent Laid-Open Publication No. 2006-235483 describe the retardation increasing agents, and the descriptions can be applied to the present invention.

[Dope Producing Method]

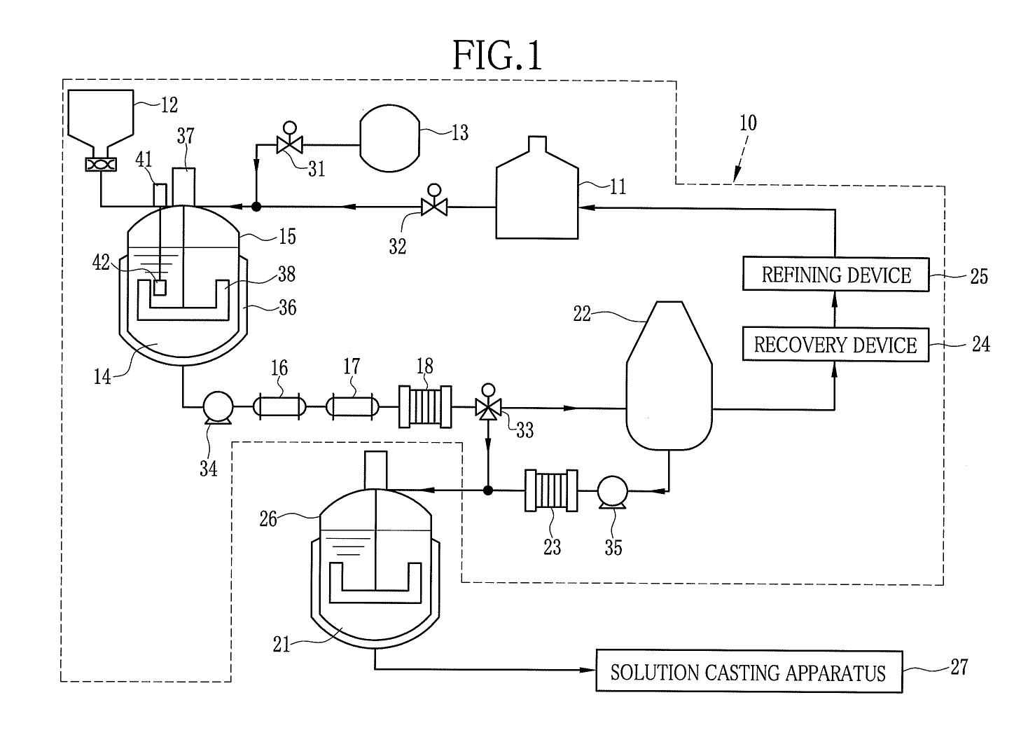

In FIG. 1, a dope producing apparatus 10 is provided with a solvent tank 11, a hopper 12, an additive tank 13, a mixing tank 15, a heater 16, a temperature controller 17, a filtration device 18, a flash device 22, and a filtration device 23.

The solvent tank 11 stores a solvent. The hopper 12 supplies cellulose acylate. The additive tank 13 stores an additive. In the mixing tank 15, the solvent, the cellulose acylate, and the additive are mixed to make a mixture 14 which is in a liquid state. The heater 16 heats the mixture 14. The temperature controller 17 adjusts temperature of the heated mixture 14. The mixture 14 sent from the temperature controller 17 is filtered through the filtration device 18 and thus a dope 21 is obtained. The flash device 22 adjusts concentration of the dope 21 sent from the filtration device 18. Thereafter, the dope 21 is filtered through the filtration device 23.

The dope producing apparatus 10 is further provided with a recovery device 24 and a refining device 25. The recovery device 24 recovers the solvent. The refining device 25 refines the recovered solvent. The dope producing apparatus 10 is connected to a solution casting apparatus 27 via a stock tank 26. Valves 31 to 33 and pumps 34 and 35 are provided in the dope producing apparatus 10. The valves 31 to 33 adjust liquid flow amounts. The pumps 34 and 35 feed liquids. The positions of the valves 31 to 33 and the pumps 34 and 35, and the number of the pumps may be changed as necessary.

The dope 21 is prepared by the following method using the dope producing apparatus 10. By opening the valve 32, the solvent is fed from the solvent tank 11 to the mixing tank 15. Next, the cellulose acylate is fed from the hopper 12 to the mixing tank 15. Cellulose acylate may be continuously fed to the mixing tank 15 using a feeding device (not shown) which continuously measures the amount of the cellulose acylate while feeding it. Alternatively, the cellulose acylate may be intermittently fed to the mixing tank 15 using a feeding device (not shown) which feeds a given amount of the cellulose acylate after the amount of the cellulose acylate is measured. By opening and closing the valve 31, a necessary amount of the additive solution is fed from the additive tank 13 to the mixing tank 15.

The additive may be fed in a state of a solution. In addition, in the case the additive is in a liquid state at room temperature, the additive may be fed to the mixing tank 15 in the liquid state. In the case the additive is in the solid state, the additive may be fed to the mixing tank 15 using a hopper or the like. In the case a plurality of additives are added, a solution in which the additives are dissolved may be put in the additive tank 13. Alternatively, a plurality of additive tanks may be used. In this case, each additive tank contains a solution in which an additive is dissolved. Each additive tank is connected to the mixing tank 15 through an independent pipe to feed the solution.

As described above, the solvents, the cellulose acylate, and the additives are put in the mixing tank 15 in this order. However, the order is not limited. The additive is not necessarily mixed with the cellulose acylate and the solvent in the mixing tank 15. The additive may be mixed to a mixture of the cellulose acylate and the solvent by an inline mixing method in a subsequent step.

It is preferable that the mixing tank 15 is provided with a jacket 36, a first stirrer 38, and a second stirrer 42. The jacket 36 covers an outer surface of the mixing tank 15. A heat transfer medium is supplied to a space between the jacket 36 and the mixing tank 15. The first stirrer 38 is rotated by a motor 37. The second stirrer 42 is rotated by a motor 41. The temperature of the mixing tank 15 is adjusted by the heat transfer medium, and a preferable temperature range is −10° C. to 55° C. By using the first stirrer 38 and the second stirrer 42 selectively, the mixture 14 in which the cellulose acylate is swelled by the solvent is obtained. It is preferable that the first stirrer 38 has an anchor blade, and the second stirrer 42 is an eccentric stirrer of a dissolver type.

Next, the mixture 14 is fed to the heater 16 using the pump 34. It is preferable that the heater 16 is a pipe (not shown) with a jacket. A heat transfer medium is passed through a space between the pipe and the jacket. In addition, it is preferable that the heater 16 has a pressurizing section (not shown) to pressurize the mixture 14. With the use of the heater 16, solid contents in the mixture 14 are effectively and efficiently dissolved under a heated condition, or a pressurized and heated condition. Hereinafter, a method in which the solid contents are dissolved in the solvent by heating is referred to as a heat-dissolving method. In the heat-dissolving method, it is preferable to heat the mixture 14 to a temperature in a range of 0° C. to 97° C.

Alternatively, a cool-dissolving method may be used. In the cool-dissolving method, dissolution of the solid contents is enhanced while the mixture 14 is kept at a predetermined temperature, or cooled to a low temperature. In the cool-dissolving method, it is preferable to cool the mixture 14 to a temperature in a range of −100° C. to −10° C. With the use of the above heat-dissolving method or the cool-dissolving method, the cellulose acylate is sufficiently dissolved in the solvent.

After the temperature of the mixture 14 is adjusted at approximate room temperature using the temperature controller 17, the mixture 14 is filtered through the filtration device 18 to remove foreign substances such as impurities and aggregation. Hereinafter, the mixture 14 is referred to as the dope 21. An average pore diameter of the filter used in the filtration device 18 is preferably at most 100 μm. It is preferable that a filtration flow volume is at least 50 liter/hr.

After the filtration, the dope 21 is fed to the stock tank 26 through the valve 33, and temporarily stored. Thereafter, the dope 21 is used for the film production.

As described above, the method in which the solid contents are swelled and then dissolved to make the solution needs longer time for preparing the dope, especially when the concentration of the cellulose acylate in the solution is increased. Such method has a problem in production efficiency. In this case, it is preferable to prepare a dope having a lower concentration than a required concentration, and then concentrate the dope to achieve the required concentration. For example, the dope 21 is fed to the flash device 22 after the filtration through the filtration device 18. In the flash device 22, a part of the solvent of the dope 21 is evaporated for concentration. The concentrated dope 21 is taken out of the flash device 22 through the pump 35 and fed to the filtration device 23. It is preferable that the temperature of the dope 21 is within a range of 0° C. to 200° C. at the time of filtration. The dope 21 from which foreign substances are removed through the filtration device 23 is fed to the stock tank 26 and temporarily stored therein. Thereafter, the dope 21 is used for the film production. Since concentrated dope 21 may contain foam, it is preferable to perform defoaming before the dope 21 is fed to the filtration device 23. Various known defoaming methods may be used, for example, a method to apply ultrasound to the dope 21.

The solvent vapors generated by flash evaporation in the flash device 22 are condensed in the recovery device 24 having a condenser (not shown). Thereby, the solvent vapors are condensed into a liquid and recovered. The recovered solvent is refined in the refining device 25, and reused as a solvent for use in the dope production. Such recovering and refining of the solvent vapors are advantageous in reducing production cost. In addition, since recovering and refining are performed in a closed system, adverse effects to humans and the environment are prevented.

Thus, the dope 21 having the cellulose acylate concentration of not less than 5 wt % and not more than 40 wt % is prepared. It is more preferable that the cellulose acylate concentration is not less than 15 wt. % and not more than 30 wt. %. It is furthermore preferable that the cellulose acylate concentration is not less than 17 wt. % and not more than 25 wt. %. It is preferable that the additive concentration is not less than 1 wt. % and not more than 20 wt. % with respect to a total solid content.

Materials, raw materials, and dissolving methods of additives, filtration methods, defoaming, and adding methods are detailed in paragraphs [0517] to [0616] of Japanese Patent Laid-Open Publication No. 2005-104148, and the above descriptions can be applied to the present invention.

[Apparatus and Method for Producing Film]

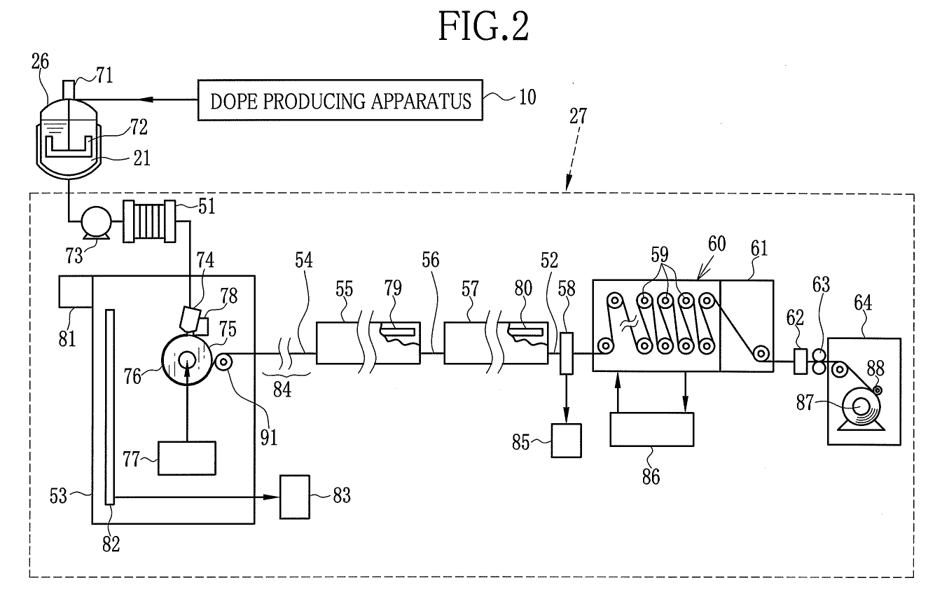

In FIG. 2, the solution casting apparatus 27 has a filtration device 51, a casting chamber 53, a first tenter 55, a second tenter 57, an edge slitting device 58, a drying chamber 60, a cooling chamber 61, a neutralization device 62, a pair of knurling rollers 63, and a winding chamber 64. The edge slitting device 58 cuts off both side edge portions of a film 52 sent from the second tenter 57. In the drying chamber 60, the film 52 is bridged across a plurality of rollers 59 and dried while being conveyed.

The filtration device 51 removes foreign substances from the dope 21 fed from the stock tank 26. In the casting chamber 53, the dope 21 filtered through the filtration device 51 is cast and a casting film 76 is formed. The casting film 76 is peeled off as a wet film 54. In the first tenter 55, the wet film 54 is dried while being conveyed in a state that side edge portions thereof are held, and thus an intermediate film 56 is obtained. Thereafter, in the second tenter 57, the intermediate film 56 is dried while being conveyed, and thus the film 52 that is the cellulose acylate film is produced. The film 52 is cooled in the cooling chamber 61. An amount of charged voltage of the film 52 is reduced in the neutralization device 62. Embossing processing is performed to the side edge portions of the film 52 using the pair of knurling rollers 63. Then, the film 52 is wound in the winding chamber 64.

The stock tank 26 is provided with a stirrer 72 which is rotated by a motor 71. The dope 21 is stirred by the rotation of the stirrer 72. Thereafter, the dope 21 in the stock tank 26 is fed to the filtration device 51 through a pump 73.

The casting chamber 53 is provided with a casting die 74 and a drum 75 for casting. The dope 21 is cast through the casting die 74 onto an outer peripheral surface (hereinafter referred to as casting surface) of the rotating drum 75, which is the support.

The drum 75 is provided with a heat transfer medium circulation device 77. The heat transfer medium circulation device 77 supplies a heat transfer medium inside the drum 75 to control the temperature of the casting surface of the drum 75. A flow path (not shown) of the heat transfer medium is formed inside the drum 75. The casting surface of the drum 75 is kept at a predetermined temperature by passing the heat transfer medium kept at a predetermined temperature through the flow path. The casting surface of the drum 75 is set at an appropriate temperature in accordance with a kind of the solvent, kinds of solid components, a concentration of the dope 21, and the like.

A decompression chamber 78 is provided in the proximity of the casting die 74. The decompression chamber 78 sucks air from an area upstream from a casting bead with respect to a rotation direction of the drum 75 to reduce the pressure. The casting bead is the dope 21 between the casting die 74 and the drum 75.

The casting chamber 53 is provided with a temperature controller 81 and a condenser 82. The temperature controller 81 keeps the inside of the casting chamber 53 at a predetermined temperature. The condenser 82 condenses and recovers solvent vapors evaporated from the dope 21 and the casting film 76. A recovery device 83 is provided outside the casting chamber 53. The recovery device 83 recovers the condensed and liquefied solvent.

An air blower (not shown) may be provided to a transfer section 84 between the casting chamber 53 and the first tenter 55.

The first tenter 55 is provided with an air duct 79 which supplies dry air to the inside of the first tenter 55. In the first tenter 55, the wet film 54 is stretched and dried while being conveyed in a state that the side edge portions of the wet film 54 are held by a holding device. An atmospheric temperature inside the first tenter 55 is adjusted by controlling a temperature of dry air sent from the air duct 79.

The second tenter 57 is provided with an air duct 80 which supplies dry air to the inside of the second tenter 57 in a similar manner as the first tenter 55. In the second tenter 57, the intermediate film 56 sent from the first tenter 55 is stretched while being conveyed and heated in a state that the side edge portions of the intermediate film 56 are held. Thus, the film 52 is produced.

The edge slitting device 58 is provided with a crusher 85 which shreds the cut off side edge portions of the film 52.

An adsorption recovery device 86 is attached to the drying chamber 60. The adsorption recovery device 86 adsorbs and recovers solvent vapors evaporated from the film 52. The cooling chamber 61 is provided at the downstream from the drying chamber 60. A moisture control chamber (not shown) may be provided between the drying chamber 60 and the cooling chamber 61 so as to adjust a water content of the film 52.

The neutralization device 62 is a so-called compulsory neutralization device such as a neutralization bar and the like, and adjusts the charged voltage of the film 52 within a predetermined range. The installation position of the neutralization device 62 is not limited to the downstream side from the cooling chamber 61. The pair of knurling rollers 63 provides knurling to the both side edge portions of the film 52 by embossing processing. A winding roll 87 and a press roller 88 are provided inside the winding chamber 64. The winding roll 87 winds the film 52. The winding tension is controlled by the press roller 88.

Next, a first embodiment of the present invention in which the film 52 is produced using the solution casting apparatus 27 is described. The dope 21 is fed to the stock tank 26, and made constantly uniform by the rotation of the stirrer 72. Thereby, precipitation and aggregation of the solid content of the dope 21 are prevented until the casting. Various additives may be mixed with an appropriate amount during the stirring of the dope 21. Foreign substances having a particle diameter larger than a predetermined size and foreign substances in a gel state are filtered and removed from the dope 21 through the filtration device 51.

After the filtration, the dope 21 is cast from the casting die 74 onto the drum 75. It is preferable that the temperature of the dope 21 at the casting is kept constant within a range of 30° C. to 35° C. It is preferable that the temperature of the casting surface of the drum 75 is kept constant within a range of −10° C. to 10° C. It is preferable that the temperature of the casting chamber 53 is controlled by the temperature controller 81 within a range of 10° C. to 30° C. The solvent vapors evaporated inside the casting chamber 53 are recovered by the recovery device 83. Thereafter, the recovered solvent is refined and recycled as the solvent for use in the dope preparation.

The dope 21 between the casting die 74 and the drum 75 is referred to as the casting bead. The casting film 76 is formed on the casting surface of the drum 75. The casting film 76 is cooled by the drum 75 and gelated, and solidified. Upon obtaining the self supporting property, the casting film 76 is peeled off from the drum 75 while being supported by a peel roller 91. Thus, the wet film 54 is obtained. The peeling of the casting film 76 is performed when the casting film 76 obtains a sufficient hardness for conveyance regardless of the residual solvent content of the casting film 76. In the present invention, the residual solvent content (unit: wt. %) is a value on dry basis. To be more specific, the residual solvent content is calculated by a mathematical expression {x/(y−x)}×100 where x is a weight of the solvent and y is a weight of the casting film 76, the wet film 54, or an intermediate film 56 which will be described later. Hereinafter, the residual solvent content at the time of peeling the casting film 76 is referred to as “W”.

In view of production efficiency, it is preferable to cool the casting film 76 to achieve sufficient hardness even when the residual solvent content W at the peeling is high. When the exposed surfaces of the casting film 76 are sufficiently hardened by cooling, dry air may be supplied in the proximity of the casting film 76 so as to improve stability of the casting film 76 during conveyance after the casting film 76 is peeled off. In order to achieve a high production speed such as 50 m/min, it is preferable to cool the casting film 76 quickly so that the casting film 76 is sufficiently hardened for peeling even when the residual solvent content W is 140 wt. % or more. In the case the drum 75 cannot be set at a low temperature so that the casting film 76 cannot be cooled quickly, it may be necessary to upsize the drum 75 to extend the conveying time of the casting film 76. In the case the residual solvent content is higher than 320 wt. %, it is difficult to harden the casting film 76 to obtain sufficient hardness for conveying even if the casting film 76 is cooled.

The wet film 54 containing a large amount of the solvent is sent to the first tenter 55. In the first tenter 55, the side edge portions of the wet film 54 are held by pins, and the wet film 54 is conveyed in accordance with the movement of the pins. While being conveyed in the first tenter 55, the wet film 54 is dried with dry air supplied from the air duct 79 provided in the first tenter 55.

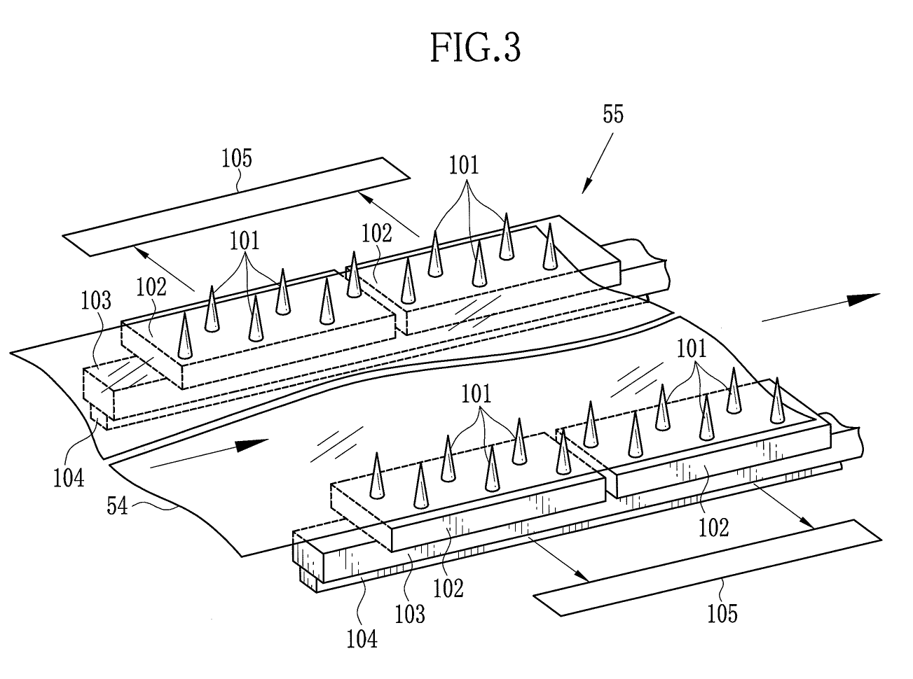

In FIG. 3, the first tenter 55 has pin plates 102, a chain 103, a rail 104 and the air duct 79 (see FIG. 1). The pin plates 102 are placed at the positions of the side edge portions of the wet film 54 and along the conveying path of the wet film 54. Each pin plate 102 has a plurality of pins 101. The plurality of the pin plates 102 are attached to each chain 103. The chain 103 is an endless chain which moves continuously. Each chain 103 is guided by the rail 104. Each rail 104 has a shifting mechanism 105.

When the wet film 54 reaches a predetermined position in the first tenter 55, the side edge portions of the wet film 54 are pierced and held by the pins 101. The shifting mechanisms 105 shift the rails 104 in the width direction of the wet film 54, and the chains 103 move along the rails 104. In accordance with the movements of the chains 103, the pin plates 102 on the chains 103 move in the width direction of the wet film 54 while holding the wet film 54. Thus, tension is applied to the wet film 54 in the width direction.

Immediately after being peeled off from the drum 75, the wet film 54 contains a large amount of the solvent and extremely unstable. As a result, it is difficult to convey the wet film 54 by rollers. In addition, such wet film 54 cannot be held by clips. For that reason, the side edge portions of the wet film 54 are pierced and held by the pins 101 as described in this embodiment. Thus, the wet film 54 is conveyed stably.

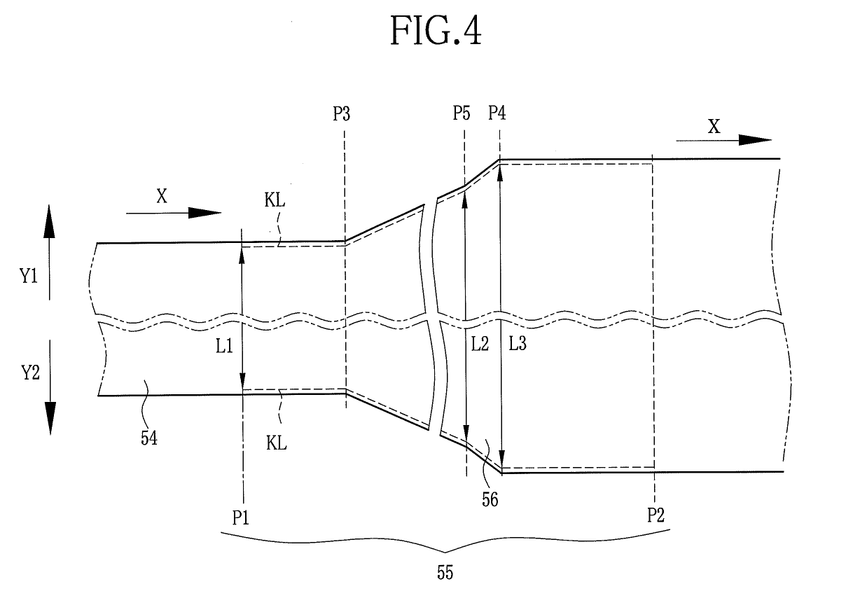

In FIG. 4, an arrow X is a conveying direction of the wet film 54. In the first tenter 55, a first position P1 is a position where the pins 101 (see FIG. 3) start to hold the wet film 54, and a second position P2 is a position where the wet film 54 is released from the pins 101. An inlet of the first tenter 55 is located upstream from the first position P1. An outlet of the first tenter 55 is located downstream from the second position P2 (both the inlet and the outlet are not shown in FIG. 4).

Solvents are gradually evaporated from the wet film 54 peeled off from the drum 75. Accordingly, the residual solvent content of the wet film 54 after the peeling tends to be lower than the residual content W at the time of peeling. It is necessary to start stretching of the wet film 54 in the width directions Y1 and Y2 as soon as possible after the peeling.

Stretching of the wet film 54 is ended when or before the residual solvent content of the wet film 54 is reduced to 25 wt. %. It is more preferable to end the stretching when or before the residual solvent content is reduced to 35 wt. %. It is furthermore preferable to end the stretching when or before the residual solvent content is reduced to 40 wt. %. A position to start the stretching is defined as a third position P3. A position to end the stretching is defined as a fourth position P4.

In the first tenter 55, the wet film 54 is dried until its residual solvent content is reduced to a predetermined value. To be more specific, the wet film 54 is dried until the residual solvent content is reduced to 25 wt. %, and the wet film 54 is stretched while being dried. This step is referred to as a first step. The wet film obtained by the first step is referred to as the intermediate film 56. Thereafter, the intermediate film 56 having the residual solvent content of 25 wt. % is further dried until the residual solvent content is reduced to 10 wt. %. This step is referred to as a second step.

In the first tenter 55, tension is applied to the wet film 54 in the width direction shown by arrows Y1 and Y2. The wet film 54 may be loosened by its own weight or shrink in the width direction Y1-Y2 in accordance with evaporation of the solvent without the application of the tension in the width directions Y1 and Y2. In order to prevent loosening of the wet film 54, the tension is applied to the wet film 54 in the width directions Y1 and Y2 (the first stretching step). It is preferable to apply the tension to the wet film 54 symmetrically with respect to a center in the width direction of the wet film 54. This helps to uniformly control molecular orientation in the width direction of the wet film 54.

Since the wet film 54 is conveyed in the first tenter 55, tension in the conveying direction X is always applied to the wet film 54. Accordingly, molecules of cellulose acylate in the wet film 54 tend to be oriented in the conveying direction X. In order to increase the Re while suppressing the increase of the Rth, the molecular orientation of the wet film 54 in the width direction is increased while the molecular orientation in the conveying direction X is relaxed.

In addition to prevention of loosening, the molecular orientation of the wet film 54 in the width direction Y1-Y2 is increased by applying tension in the width directions Y1 and Y2. Thereby, the molecular orientation of the cellulose acylate in the wet film 54 in the width direction Y1-Y2 is increased relative to the molecular orientation in the conveying direction X.

In general, it is difficult to adjust the molecular orientation in a thickness direction of the film unless the thickness of the film is adjusted. Since the film is produced with a specified thickness, the molecular orientation in the thickness direction is limited to the specified value. Accordingly, the Rth is controlled by adjustments of the molecular orientations in the conveying direction and the width direction.

By applying tension to the wet film 54 in the width directions Y1 and Y2, a width (hereinafter referred to as first width) L1 of the wet film 54 at the entrance of the first tenter 55 is stretched to a width (hereinafter referred to as second width) L2. This step is hereinafter referred to as first stretching step. Thus, the first step includes the first stretching step. The first step and the first stretching step may start and end simultaneously. Alternatively, the first stretching step may be performed between the start and the end of the first step.

Next, the second width L2 of the intermediate film 56 is stretched to a width (hereinafter referred to as third width) L3. This step is hereinafter referred to as second stretching step. The second step does not necessarily require stretching of the intermediate film 56. However, it is preferable that the second step includes the second stretching step as described in this embodiment. In the case the second step includes the second stretching step, the second step and the second stretching step may start and end simultaneously. Alternatively, the second stretching step may be performed between the start and the end of the second step.

After the second step, it is preferable to perform a width-keeping step in the first tenter 55. In the width-keeping step, the third width L3 is kept unchanged. In order to keep the third width L3, tension is applied to the intermediate film 56 in the width directions Y1 and Y2. This is because the intermediate film 56 tends to shrink by evaporation of the solvent contained in the intermediate film 56. Hereinafter, increasing the width is referred to as “stretching”. In FIG. 4, film holding lines KL (imaginary lines) denote the innermost positions, with respect to the width direction, of the side edge portions of the wet film 54 or the intermediate film 56 which are held by the pins. The first to the third widths L1 to L3 denote distances between the opposing film holding lines KL. A fifth position P5 is a position where a width of the wet film 54 is stretched to the second width L2.

The stretch ratio between the third position P3 and the fifth position P5 is within a range of not less than 5% and not more than 30%. The stretch ratio is a percentage of an increase in the width relative to the width before the stretching. For example, the stretch ratio is calculated by a mathematical expression {(L2−L1)/L1}×100.

The stretching is started when the residual solvent content is W (wt. %), and ended when or before the residual solvent content is reduced to 25 wt. %, more preferably 35 wt. %. Thus, the molecular orientation in the width direction is increased while the molecular orientation in the conveying direction X is relaxed. However, the stretching after the residual solvent content is reduced to less than 25 wt. % is ineffective in relaxing the molecular orientation in the conveying direction X. This is because solidification is promoted by drying the wet film 54.

Between the third position P3 and the fifth position P5, the stretching at the stretch ratio of less than 5% is ineffective for increasing molecular orientation in the width direction Y1-Y2. On the other hand, when the stretch ratio exceeds 30%, the wet film 54 may be torn along the film holding lines KL or the like depending on the residual solvent content. Therefore, the maximum stretch ratio of the wet film 54 in the width directions Y1 and Y2 is 30%, and the molecular orientation in the width direction Y1-Y2 can only be increased to a value corresponding to the maximum stretch ratio of 30%.

When the casting film 76 is peeled off from the drum 75 at the residual solvent content of 320 wt. % , the residual solvent content of the wet film 54 between the third position P3 and the fifth position P5 in the first tenter 55 is not less than 25 wt. % and not more than 320 wt. %. The atmospheric temperature of the conveying path of the wet film 54 inside the first tenter 55 is set at not less than 70° C. and not more than 115° C. at least in an area between the third position P3 and the fifth position P5, and the wet film 54 is stretched as described above. It is more preferable that the atmospheric temperature inside the first tenter 55 is not less than 75° C. and not more than 110° C. It is furthermore preferable that the atmospheric temperature is not less than 80° C. and not more than 105° C.

The above described temperature range of the atmosphere in the area between the third position P3 and the fifth position P5 is a range of an average atmospheric temperature in the area. The atmospheric temperature may be lower than 70° C. or higher than 115° C. in a part of the area as long as the average atmospheric temperature in the area is within the above specified range.

When the average atmospheric temperature inside the first tenter 55 is lower than 70° C., the molecular orientation in the conveying direction cannot be relaxed even if the wet film 54 is stretched in the width directions Y1 and Y2. As a result, the Rth increases relative to the Re. When the average atmospheric temperature inside the first tenter 55 is higher than 115° C., foam may be generated in the wet film 54.

Between the fifth position P5 and the fourth position P4, the residual solvent content in the intermediate film 56 is 10 wt. % or more and less than 25 wt. %. In the second step, as described above, it is preferable to perform the second stretching step in which the second width L2 is increased to the third width L3 by application of tension.

A stretch ratio between the fifth position P5 and the fourth position P4 is 0% or more to 20% or less. The second stretching step is not necessarily performed, namely, the width of the intermediate film 56 is kept unchanged at the stretch ratio of 0%. However, it is more preferable to perform the second stretch step at the stretch ratio greater than zero. In the second stretch step, a preferable range of the stretch ratio is not less than 1% and not more than 15%. Amore preferable range is not less than 2% and not more than 10%. When the stretch ratio is less than 0%, namely, when the width of the intermediate film 56 is reduced, the molecular orientation in the width direction may be reduced. When the stretch ratio is 20% or more, the intermediate film 56 may be torn. The stretch ratio of the intermediate film 56 in the first tenter 55 is calculated by a mathematical expression {(L3−L2)}/L2}×100.

Between the fifth position P5 and the fourth position P4, the average atmospheric temperature in the first tenter 55 is set at not less than 40° C. and not more than 90° C. It is more preferable that the average atmospheric temperature is not less than 45° C. and not more than 85° C. It is furthermore preferable that the average atmospheric temperature is not less than 50° C. and not more than 80° C.

The above described atmospheric temperature range in the area between the fifth position P5 and the fourth position P4 is a range of an average atmospheric temperature in the area. The atmospheric temperature may be lower than 40° C. or higher than 90° C. in a part of the area as long as the average atmospheric temperature in the area is within the above specified range.

When the average atmospheric temperature between the fifth position P5 and the fourth position P4 inside the first tenter 55 is lower than 40° C., the haze of the film 52 increases. As a result, the produced film cannot be used as an optical film which places importance on transparency. In addition, the intermediate film 56 is hardened and easily torn.

When the average atmospheric temperature between the fifth position P5 and the fourth position P4 inside the first tenter 55 is higher than 90° C., side chains of the molecules are orientated in the conveying direction X of the intermediate film 56 due to crystallization although the intermediate film 56 is stretched in the directions Y1 and Y2 and the molecular orientation in the width direction is increased. As a result, the film 52 produced from such intermediate film 56 has a high Rth relative to the Re.

The haze (unit: %) is a degree of clouding on a surface of or within a transparent film. The haze is obtained by measuring light transmission of a sample and calculating Haze (Th)=diffused light transmission (Td)/total light transmission (Tt)×100.

After the second step, a width-keeping step may be performed in the first tenter 55. It is preferable to advance drying of the intermediate film 56 during the width-keeping step. An average atmospheric temperature in an area in which the width-keeping step is performed, namely, the area between the fourth position P4 and the second position P2 may be set at the same temperature as in the second step.

After the intermediate film 56 is discharged from the first tenter 55, tension is applied to the intermediate film 56 in the conveying direction X as the intermediate film 56 is conveyed. Accordingly, it is difficult to prevent an increase in molecular orientation in the conveying direction X. However, since the molecules of the wet film 54 and the intermediate film 56 are oriented in the width direction Y1-Y2 by the first stretching step and the second stretching step in the first tenter 55, a constant balance is achieved between the molecular orientations in the conveying direction X and the width direction Y1-Y2 of the intermediate film 56. In FIG. 4, the first stretching step and the second stretching step are performed sequentially. However, it is also possible to provide an area in which stretching is not performed between the areas of the first stretching step and the second stretching step in the first tenter 55.

When the residual solvent content of the intermediate film 56 is reduced to 10 wt. % in the first tenter 55, the intermediate film 56 is discharged from the first tenter 55 and sent to the second tenter 57. After the intermediate film 56 is discharged from the first tenter 55, the residual solvent content in the intermediate film 56 may be reduced to zero. In the second tenter 57, the intermediate film 56 may be dried while being stretched in the width direction at an atmospheric temperature within a predetermined range.

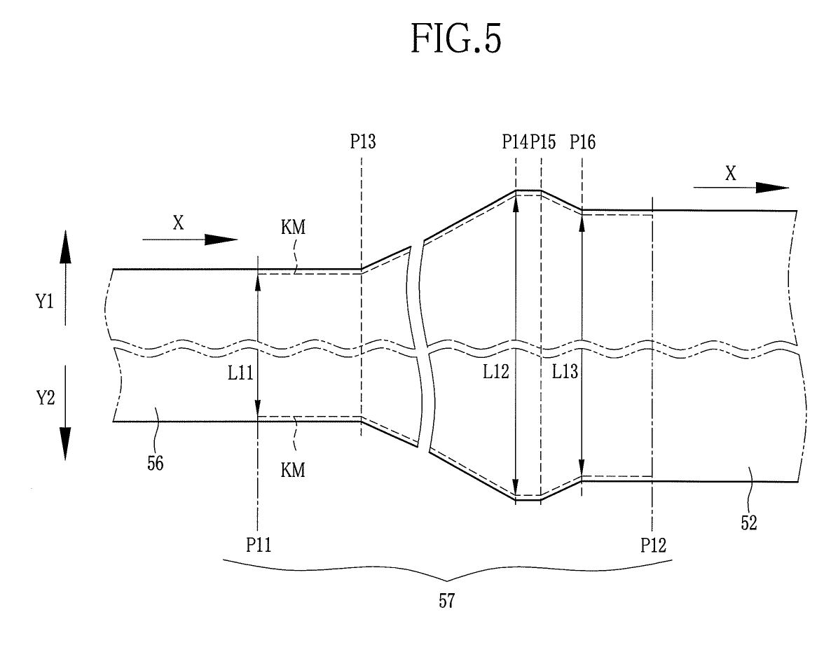

In the second tenter 57, a third step is performed. In the third step, the intermediate film 56 is stretched in the width direction in an atmospheric temperature adjusted within a predetermined range. It is preferable that the third step includes a third stretching step in which a width of the intermediate film 56 is increased by stretching. In addition, the third step may include a width-keeping step and a width-reducing step. In FIG. 5, an arrow X is a conveying direction of the intermediate film 56. In the second tenter 57, an eleventh position P11 is a position to start holding of the intermediate film 56 by a holding device, and a twelfth position P12 is a position to release the intermediate film 56. An inlet of the second tenter 57 is upstream from the eleventh position P11, and an outlet of the second tenter 57 is downstream from the twelfth position P12 (both the inlet and the outlet are not shown in FIG. 5).

In order to convey the intermediate film 56 having lower residual solvent content than the wet film 54 through the second tenter 57, it is preferable that the second tenter 57 has a clip-type holding device to hold the side edge portions of the intermediate film 56 instead of the pin-type holding device used in the first tenter 55.

The intermediate film 56 is more solidified than the wet film 54. For this reason, the intermediate film 56 is heated and softened in the second tenter 57. The third stretching step is performed to the intermediate film 56 already softened or while the intermediate film 56 is softened.

In the second tenter 57, when the residual solvent content in the intermediate film 56 is less than 10 wt. %, the width of the intermediate film 56 is increased from a width L11 (hereinafter referred to as an eleventh width) to a width L12 (hereinafter referred to as a twelfth width) by applying tension thereto. The eleventh width L11 is the width of the intermediate film 56 at the entrance of the second tenter 57.

A thirteenth position P13 is a position to start the stretching of the intermediate film 56 from the eleventh width L11 to the twelfth width L12. A fourteenth position P14 is a position where the stretching of the intermediate film 56 started from the thirteenth position P13 is ended.

The stretch ratio between the thirteenth position P13 and the fourteenth position P14 is not less than 10% and not more than 60%. It is preferable that the stretch ratio is not less than 15% and not more than 55%. It is furthermore preferable that the stretch ratio is not less than 20% and not more than 50%. When the stretch ratio is 10% or less, stretching is almost ineffective in increasing the molecular orientation in the width direction. When the stretch ratio is 60% or more, the haze may increase or the intermediate film 56 may be torn. The stretch ratio of the intermediate film 56 in the second tenter 57 is calculated by a mathematical expression {(L12−L11)/L11}×100.

Between the thirteenth position P13 and the fourteenth position P14, the atmospheric temperature inside the second tenter 57 is set at not less than 160° C. and not more than 195° C. It is more preferable that the atmospheric temperature is not less than 165° C. and not more than 190° C. It is furthermore preferable that the atmospheric temperature is not less than 170° C. and not more than 185° C.

When the atmospheric temperature between the thirteenth position P13 and the fourteenth position P14 inside the second tenter 57 is set lower than 160° C. during the stretching of the intermediate film 56, the haze of the intermediate film 56 increases. This is because the intermediate film 56 is not sufficiently softened when the atmospheric temperature is low. As a result, stress due to stretching increases and a distance between molecules increases. Accordingly, the produced film cannot be used as an optical film, which places importance on transparency. In addition, the intermediate film 56 becomes easily torn.

When the atmospheric temperature between the thirteenth position P13 and the fourteenth position P14 is set to be higher than 195° C., the side chains of the molecules are orientated in the conveying direction X of the intermediate film 56 due to crystallization although the intermediate film 56 is stretched in the directions Y1 and Y2 and the molecular orientation in the width direction is increased. As a result, the Rth of the intermediate film 56 increases relative to the Re.

When the width of the intermediate film 56 is reduced from the twelfth width L12, a reduced width is referred to as a width L13 (hereinafter referred to as thirteenth width). A fifteenth position P15 is a position to start the width-reduction of the intermediate film 56 from the twelfth width L12 to the thirteenth width L13. A sixteenth position P16 is a position to end the width-reduction started from the fifteenth position P15.

Between the fifteenth position P15 and the sixteenth position P16, tension is applied to the intermediate film 56 in the width direction Y1-Y2 regardless of whether the twelfth width L12 is kept unchanged or reduced to the thirteenth width L13. To reduce the width of the intermediate film 56, a natural shrinking force of the intermediate film 56 is utilized while the intermediate film 56 is held by a holding device, and the width of the intermediate film 56 is controlled by application of tension. In FIG. 5, film holding lines KM (imaginary lines) denote the innermost positions with respect to the width direction of the side edge portions of the intermediate film 56 which are held by the holding device. The widths L11 to L13 denote distances between the opposing film holding lines KM.

It is preferable that a width reduction ratio is 10% or less. In the present invention, the twelfth width L12 may be kept unchanged. Accordingly, the width reduction ratio is 0% or more and at most 10%. By reducing the width after stretching, the molecular orientation achieves more appropriate condition in view of dimension stability against thermal shrinkage (thermal shrinkage resistance). When the width reduction ratio is higher than 10%, the effect of the earlier stretching may be reduced. The width reduction ratio of the intermediate film 56 in the second tenter 57 is calculated by {(L12−L13)/L13}×100.

By adjusting the atmospheric temperature in the first and the second tenters 55 and 57 during stretching in accordance with the residual solvent contents of the wet film 54 and the intermediate film 56, orientation of side chains of molecules in the conveying direction X caused by crystallization is prevented. As a result, the high Rth relative to the Re is prevented. The molecular orientation in the width direction is significantly increased, and thus the Re is adjusted in a wide range. Stretching also prevents an increase in the haze.

As shown in FIG. 1, after the film 52 is dried in the second tenter 57 until the residual solvent content of the film 52 is reduced to a predetermined value, the side edge portions of the film 52 are cut off by the edge slitting device 58. The cut side edge portions are sent to the crusher 85 by a cutter blower (not shown). The crusher 85 shreds the cut side edge portions into chips. The chips are reused for dope preparation and thus the raw material is efficiently reused. This cutting step may be omitted. However, it is preferable to perform the cutting step between the casting step and the winding step of the film.

After the both side edge portions are cut off, the film 52 is sent to the drying chamber 60 and further dried. In the drying chamber 60, the film 52 is bridged across the rollers 59 and conveyed. The inner temperature of the drying chamber 60 is not particularly limited. However, it is preferable that the inner temperature is set to be not less than 50° C. and not more than 160° C. It is preferable to divide the drying chamber 60 into plural sections in the conveying direction of the film 52 so as to change the temperature of air supplied to each section. In addition, it is preferable to provide a predrying chamber (not shown) between the edge slitting device 58 and the drying chamber 60 to predry the film 52. Thereby, an abrupt increase of the film temperature in the drying chamber 60 is prevented. As a result, changes in shapes and conditions of the film 52 are prevented. The solvent vapors evaporated in the drying chamber 60 are adsorbed and recovered by the adsorption recovery device 86. Air from which the solvent content is removed is supplied to the drying chamber 60 as dry air.

The film 52 is cooled to the approximate room temperature in the cooling chamber 61. In the case the moisture control chamber is provided between the drying chamber 60 and the cooling chamber 61, it is preferable to blow air at a predetermined temperature and humidity to the film 52 in the moisture control chamber. Thereby, curling and winding defects of the film 52 are prevented.

The neutralization device 62 sets the charged voltage of the film 52 at a predetermined value during conveyance. It is preferable that the charged voltage after neutralization has a value in a range of −3 kV to +3 kV. In addition, it is preferable to provide knurling to the film 52 using the pair of knurling rollers 63. It is preferable that a height of the knurling has a value in a range of 1 μm to 200 μm.

The film 52 is wound by the winding roll 87 in the winding chamber 64, and thus a film roll is formed. It is preferable to wind the film 52 while appropriate tension is applied to the film 52 by the press roller 88. It is preferable to gradually change the tension from the start to the end of winding so as to prevent excessive tightening of the film roll. It is preferable that a width of the film 52 to be wound is in a range of 1400 mm and 3400 mm. However, the present invention is applicable to films having a width wider than 3400 mm. The present invention is also applicable to production of thin films having a thickness of at least 15 μm and at most 100 μm.

Next, a second embodiment of the method for producing the film 52 using the solution casting apparatus 27 is described. In the second embodiment, the same reference numbers are assigned to the same components as those in the first embodiment. Descriptions of the same components as those in the first embodiment are omitted.

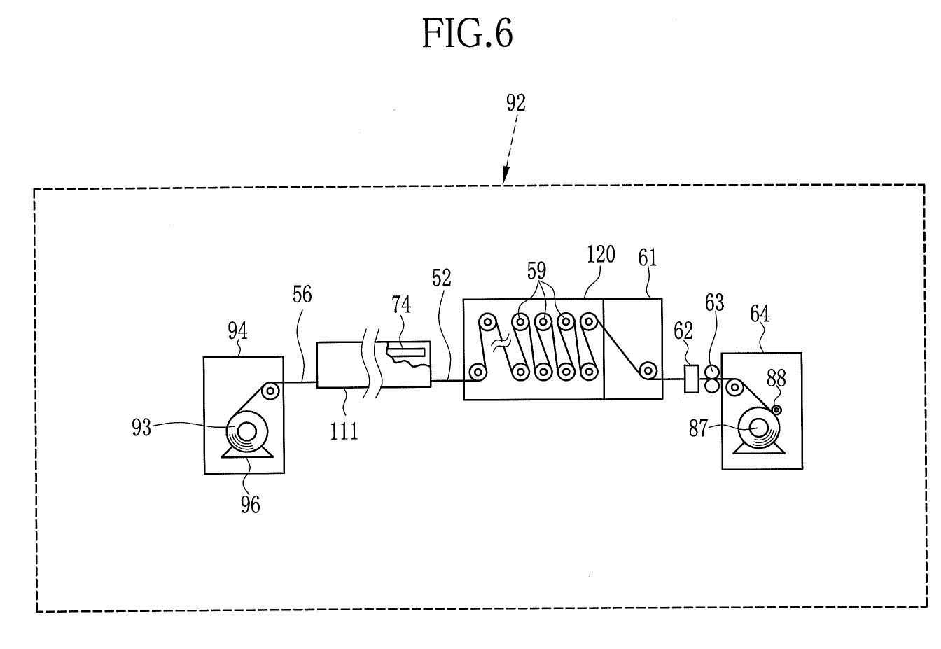

In FIG. 6, in an off-line stretching apparatus 92 of the second embodiment of the present invention, the intermediate film 56 is unrolled from an intermediate film roll 93 and fed to a second tenter 111. In the second tenter 111, the intermediate film 56 is stretched in the width direction. In this case, in the solution casting apparatus 27 of the first embodiment shown in FIG. 2, in order to form the intermediate film roll 93, the intermediate film 56 discharged from the first tenter 55 is sent to the winding chamber 64 through the drying chamber 60 and the cooling chamber 61 without passing through the second tenter 57, and the intermediate film 56 is wound into the intermediate film roll 93 in the winding chamber 64. In the off-line stretching apparatus 92 shown in FIG. 6, the same reference numbers are assigned to the same apparatuses and the same components as those in FIG. 2, and descriptions thereof are omitted.

Referring back to FIG. 6, the off-line stretching apparatus 92 has a film feeding chamber 94, the second tenter 111, a stress relaxation chamber 120, and the cooling chamber 61, and the winding chamber 64 in this order. In the second tenter 111, the intermediate film 56 is heated and stretched. In the stress relaxation chamber 120, the film 52 is heated so as to relax stress, which is applied to the film 52 by stretching.

The film feeding chamber 94 has a film feeding device 96 in which the intermediate film roll 93 is set. The film feeding device 96 has a mounting shaft (not shown) on which the intermediate film roll 93 is set. The intermediate film 56 is unrolled and fed from the intermediate film roll 93. This intermediate film 56 has the specific Re and the Rth adjusted in the first tenter 55 (see FIG. 2). It is also possible to provide plural film feeding devices 96 so as to feed from plural intermediate film rolls 93 with various Re and Rth settings to the second tenter 57 sequentially.

The second tenter 111, the cooling chamber 61, and the winding chamber 64 are the same as those in the first embodiment, so descriptions thereof are omitted.

In the first embodiment, the stretching in the first tenter 55 and the stretching in the second tenter 57 are performed in a row, whereas in the second embodiment, the intermediate film 56 stretched in the first tenter 55 is pulled out from the intermediate film roll 93 and stretched in the second tenter 111. The intermediate films 56 having different ratios of molecular orientations in the conveying direction and the width direction can be stretched in the second tenter 111 of the off-line stretching apparatus 92 with predetermined stretching conditions, and thus the Re and the Rth of the intermediate films 56 can be adjusted to required values. For example, the intermediate film rolls 93 of the intermediate films 56 each having predetermined Re and Rth are stored, and when necessary, each of the intermediate films 56 is heated and stretched in the second tenter 111 to produce the film 52 having a necessary combination of the Re and Rth. In the case plural film feeding devices 96 are used, plural kinds of the films 52 having different Re and Rth values can be produced efficiently by stretching the plural kinds of the intermediate films 56 one after another while switching the film feeding device 96 to feed the intermediate film 56 and changing the stretching conditions in the second tenter 111.

The films produced in the above-described first and second embodiments are suitable for optical films for use in LCDs. In particular, the produced films are more suitable for retardation films for use in polarizing filters.

Hereinafter, specific examples of the present invention are described. However, present invention is not limited to the following examples.

### EXAMPLE 1

The dope 21 having the following composition was prepared using the dope producing apparatus 10 in FIG. 1.

| | |
|---|---|
| Cellulose triacetate (degree of substitution was 2.94, | 100 pts. wt. |
| viscometric average degree of polymerization was | |
| 305.6%, viscosity of 6 wt. % of dichloromethane | |
| solution was 350 mPa · s) | |
| Dichloromethane (a first solvent component) | 390 pts. wt. |
| Methanol (a second solvent component) | 60 pts. wt. |
| Citric acid ester mixture (a mixture of citric acid, citric | 0.006 pts. wt. |
| acid monoethyl ester, citric acid diethyl ester and citric | |
| acid triethyl ester) | |
| Fine particles (silicon dioxide, average particle | 0.05 pts. wt. |
| diameter: 15 nm, Mohs hardness: approximately 7) | |
| N-N′-di-m-tolyl-N″-p-methoxyphenyl-1,3,5-triazine- | 8 pts. wt. |
| 2,4,6-triamine (retardation increasing agent) | |

Plural films 52 were produced from the above described dope using the solution casting apparatus 27 in FIG. 2. The film 52 was formed to have the thickness of 45 μm. The conveying speed of the film 52 was 60 m/min. In the example 1, the film which satisfies the requirements of the present invention is produced. The inner temperature of the first tenter 55 was set at 100° C. until the residual solvent content of the wet film 54 was reduced to 25 wt. %. In the first tenter 55, the wet film 54 was stretched in the width direction at a stretch ratio of 10% until the residual solvent content was reduced to 25 wt. %. In the first tenter 55, a stretch temperature was set at 50° C. when the residual solvent content of the intermediate film 56 was 10 wt. % or more and less than 25 wt. %. The stretch temperature is an average atmospheric temperature in the first tenter 55 or the second tenter 57 during stretching of the wet film 54 or the intermediate film 56. In the first tenter 55, the intermediate film 56 was stretched in the width direction at the stretch ratio of 5% when the residual solvent content of the intermediate film 56 was 10 wt. % or more and less than 25 wt. %. The stretch temperature in the second tenter 57 was set at 180° C. when the residual solvent content of the intermediate film 56 was less than 10 wt. %. In the second tenter 57, the intermediate film 56 was stretched in the width direction at the stretch ratio of 40% when the residual solvent content of the intermediate film 56 was less than 10 wt. %. Hereinafter, in the examples 1 to 12, the film 52 was produced while satisfying the producing conditions of the present invention. In the comparative examples 1 to 7, producing conditions of the present invention were not satisfied.

### EXAMPLE 2

The conditions in the example 2 were the same as those in the example 1 except that the stretch temperature was set at 70° C. in the first tenter 55 until the residual solvent content of the wet film 54 was reduced to 25 wt. %.

### EXAMPLE 3

The conditions in the example 3 were the same as those in the example 1 except that the stretch temperature was set at 115° C. in the first tenter 55 until the residual solvent content of the wet film 54 was reduced to 25 wt. %.

### EXAMPLE 4

The conditions in the example 4 were the same as those in the example 1 except that the stretch temperature was set at 40° C. in the first tenter 55 when the residual solvent content of the intermediate film 56 was 10 wt. % or more and less than 25 wt. %.

### EXAMPLE 5

The conditions in the example 5 were the same as those in the example 1 except that the stretch temperature was set at 90° C. in the first tenter 55 when the residual solvent content of the intermediate film 56 was 10 wt. % or more and less than 25 wt. %.

### EXAMPLE 6

The conditions in the example 6 were the same as those in the example 1 except that the stretch ratio was 0% in the first tenter 55 when the residual solvent content of the intermediate film 56 was reduced to 10 wt. % or more and less than 25 wt. %.

### EXAMPLE 7

The conditions in the example 7 were the same as those in the example 1 except that the stretch temperature was set at 160° C. in the second tenter 57 when the residual solvent content of the intermediate film 56 was less than 10 wt. %.

### EXAMPLE 8

The conditions in the example 8 were the same as those in the example 1 except that the stretch temperature was set at 195° C. in the second tenter 57 when the residual solvent content of the intermediate film 56 was less than 10 wt. %.

### EXAMPLE 9

The conditions in the example 9 were the same as those in the example 1 except that the stretch ratio was set to 10% in the second tenter 57 when the residual solvent content of the intermediate film 56 was less than 10 wt. %.

### EXAMPLE 10

The conditions in the example 10 were the same as those in the example 1 except that the stretch ratio was set to 60% in the second tenter 57 when the residual solvent content of the intermediate film 56 was less than 10 wt. %.

### EXAMPLE 11

The conditions in the example 11 were the same as those in the example 1 except that the stretch ratio was set to 9% in the second tenter 57 when the residual solvent content of the intermediate film 56 was less than 10 wt. %.

### EXAMPLE 12

The conditions in the example 12 were the same as those in the example 1 except that the stretch ratio was set to 65% in the second tenter 57 when the residual solvent content of the intermediate film 56 was less than 10 wt. %.

### COMPARATIVE EXAMPLE 1

The conditions in the comparative example 1 were the same as those in the example 1 except that the stretch temperature was set at 60° C. in the first tenter 55 until the residual solvent content of the wet film 54 was reduced to 25 wt. %.

### COMPARATIVE EXAMPLE 2

The conditions in the comparative example 2 were the same as those in the example 1 except that the stretch temperature was set at 120° C. in the first tenter 55 until the residual solvent content of the wet film 54 was reduced to 25 wt. %. As a result, foam was generated in the wet film 54, and the wet film 54 was torn without being stretched. Accordingly, subsequent steps were not performed and the film 52 was not produced.

### COMPARATIVE EXAMPLE 3

The conditions in the comparative example 3 were the same as those in the example 1 except that the stretching was not performed (the stretch ratio was 0%) in the first tenter 55 until the residual solvent content of the wet film 54 was reduced to 25 wt. %.

### COMPARATIVE EXAMPLE 4

The conditions in the comparative example 4 were the same as those in the example 1 except that the stretch temperature was set at 100° C. in the first tenter 55 when the residual solvent content of the intermediate film 56 was 10 wt. % or more and less than 25 wt. %.

### COMPARATIVE EXAMPLE 5

The conditions in the comparative example 5 were the same as those in the example 1 except that the stretch temperature was set at 30° C. in the first tenter 55 when the residual solvent content of the intermediate film 56 was 10 wt. % or more and less than 25 wt. %.

### COMPARATIVE EXAMPLE 6

The conditions in the comparative example 6 were the same as those in the example 1 except that the stretch temperature was set at 150° C. in the second tenter 57 when the residual solvent content of the intermediate film 56 was less than 10 wt. %.

### COMPARATIVE EXAMPLE 7

The conditions in the comparative example 7 were the same as those in the example 1 except that the stretch temperature was set at 200° C. in the second tenter 57 when the residual solvent content of the intermediate film 56 was less than 10 wt. %.

Table 1 shows conditions and results of the examples 1 to 12 and the comparative examples 1 to 7. The Re was obtained by taking a part of the film 52 which was wound in the winding chamber 64 as a sample, and measuring the Re of the sample. To be more specific, the measurements of the Re (unit: nm) were performed at 25° C., 60% RH. The Rth (unit: nm) was measured also at 25° C., 60% RH. The results of the Rth/Re are shown in the Table 1. The haze (unit: %) was obtained by measuring optical transmission of the sample at 25° C., 60% RH, and calculating (diffused light transmission Td/total light transmission Tt)×100.

TABLE 1

| | | | | | Second | | | | | | |
|---|---|---|---|---|---|---|---|---|---|---|---|
| | First tenter | | | | tenter | | | | | | |
| | Solvent 1 | | Solvent 2 | | Solvent 3 | | Re | Rth | Rth/ | Haze | |
| | ST | SR | ST | SR | ST | SR | (nm) | (nm) | Re | (%) | E |
| E1 | 100 | 10 | 50 | 5 | 180 | 40 | 60 | 120 | 2 | 0.5 | A |
| E2 | 70 | 10 | 50 | 5 | 180 | 40 | 60 | 150 | 2.5 | 0.5 | B |
| E3 | 115 | 10 | 50 | 5 | 180 | 40 | 60 | 110 | 1.8 | 0.5 | A |
| E4 | 100 | 10 | 40 | 5 | 180 | 40 | 60 | 115 | 1.9 | 0.8 | B |
| E5 | 100 | 10 | 90 | 5 | 180 | 40 | 55 | 150 | 2.7 | 0.5 | B |
| E6 | 100 | 10 | 50 | 0 | 180 | 40 | 50 | 110 | 2.2 | 0.5 | A |
| E7 | 100 | 10 | 50 | 5 | 160 | 40 | 65 | 115 | 1.8 | 0.8 | B |
| E8 | 100 | 10 | 50 | 5 | 195 | 40 | 55 | 140 | 2.5 | 0.5 | B |
| E9 | 100 | 10 | 50 | 5 | 180 | 10 | 35 | 100 | 2.9 | 0.5 | B |
| E10 | 100 | 10 | 50 | 5 | 180 | 60 | 68 | 130 | 1.9 | 0.8 | B |
| E11 | 100 | 10 | 50 | 5 | 180 | 9 | 30 | 90 | 3.0 | 0.5 | B |
| E12 | 100 | 10 | 50 | 5 | 180 | 65 | 72 | 132 | 1.8 | 1.0 | B |
| C1 | 60 | 10 | 50 | 5 | 180 | 40 | 60 | 200 | 3.3 | 0.5 | F |
| C2 | 120 | 10 | — | — | — | — | — | — | — | — | F |
| C3 | 100 | 0 | 50 | 5 | 180 | 40 | 39 | 120 | 3.1 | 0.5 | F |
| C4 | 100 | 10 | 100 | 5 | 180 | 40 | 52 | 200 | 3.8 | 0.5 | F |
| C5 | 100 | 10 | 30 | 5 | 180 | 40 | 60 | 110 | 1.8 | 2 | F |
| C6 | 100 | 10 | 50 | 5 | 150 | 40 | 67 | 113 | 1.7 | 2 | F |
| C7 | 100 | 10 | 50 | 5 | 200 | 40 | 45 | 170 | 3.8 | 0.5 | F |

In the Table 1, “E1” to “E12” denote the examples 1 to 12. “C1” to “C7” denote the comparative examples 1 to 7. “Solvent 1” denotes that the residual solvent content in the wet film 54 was 25 wt. % or more. “Solvent 2” denotes that the residual solvent content in the intermediate film 56 was 10 wt. % or more and less than 25 wt. %. “Solvent 3” denotes that the residual solvent content in the intermediate film 56 was less than 10 wt. %. “ST” denotes the stretch temperature (unit: ° C.). “SR” denotes the stretch ratio (%). A column “E” shows the result of the evaluation.

In the Table 1, “-” in the row of the comparative example 2 denotes that it was impossible to perform the required step, so the stretch temperature and the stretch ratio were not shown. Based on the Re, the Rth/Re, and the haze, the produced film was evaluated using the following criteria.
F (failure): the produced film was evaluated as F when the haze was higher than 1.0 or the Rth/Re was higher than 3.0. Such film cannot be used as a retardation film for use in a polarizing filter, and was judged as defective. In addition, the comparative example 2, in which the required steps were not performed, was also evaluated as F for the sake of convenience.
B (satisfactory): the produced film was evaluated as B when the haze was at most 1.0, and the Re was at least 30 nm, and the Rth/Re was at most 3.0. Such film can be used as the retardation film for use in the polarizing filter.
A (excellent): among the films evaluated as B, the produced film was evaluated as A when the haze was at most 0.7, and the Re was at least 30 nm, and the Rth/Re was less than 2.5. Such film is excellent for the retardation film for use the polarizing filter.

Regarding the comparative examples 1 to 7 which do not satisfy the requirements of the present invention, the comparative example 2 failed to produce the film. In the comparative examples 5 and 6, the Re was higher than 30 nm and the Rth was suppressed so that the Rth/Re was less than 3.0. However, since the haze was higher than 1.0, the produced films were not satisfactory. In the comparative examples 1, 3, 4, and 7, the Rth/Re was higher than 3.0 so that the produced films were not satisfactory.

On the other hand, in the examples 1 to 12 which satisfy the requirements of the present invention, the produced film has the Re of at least 30 nm, and the Rth/Re which is the Rth relative to the Re is at most 3.0, and the haze is at most 1.0. According to the present invention, as described above, the film which has the Re of at least 30 nm with the suppressed Rth/Re and the low haze is produced.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A method for producing a film comprising the steps of:
(a) forming a casting film by casting a dope onto a moving support, said dope containing cellulose acylate and a solvent;
(b) peeling said casting film as a film from said support after said casting film obtaining self supporting property by cooling;
(c) drying said film at an average atmospheric temperature of not less than 70° C. and not more than 115° C. until a residual solvent content of said film being reduced to 25 wt. % while stretching said film in a width direction;
(d) enhancing drying of said film at said average atmospheric temperature of not less than 40° C. and not more than 90° C. so as to reduce said residual solvent content to 10 wt. %, said step (d) being performed after said step (c); and
(e) stretching said film in a width direction at said atmospheric temperature set at not less than 160° C. and not more than 195° C., said residual solvent content being at most 10 wt. %, said step (e) being performed after said step (d).

2. The method according to claim 1, wherein a stretch ratio in said step (e) is not less than 10% and not more than 60%.

3. The method according to claim 1, wherein said steps (c) and (d) are performed using a pin tenter in which side edge portions of said film are held by pins.

4. The method according to claim 1, wherein said step (e) is performed using a clip tenter in which side edge portions of said film are held by clips.
